(19) United States
(12) Patent Application Publication
(10) Pub. No.: US 2007/0254105 A1
(43) Pub. Date: Nov. 1, 2007

(54) System and method for an antiquing paste

(76) Inventor: Richard David Stovall SR., Memphis, TN (US)

Correspondence Address: EDWINA THOMAS WASHINGTON, 8307 WALNUT TRAIL COVE, MEMPHIS, TN, 38018, US

(21) Appl. No.: 11/413,530

(22) Filed: Apr. 29, 2006

(51) Int. Cl. B05D 1/32; B05D 3/10; C04B 14/00

(52) U.S. Cl. 427/337; 427/272; 106/811

(57) ABSTRACT

Systems are provided for imparting an antiquing characteristic to a substrate. The substrate includes a base coat of color such as an acid stain. A masking composition is applied over the substrate having the acid stain. Another of layer of acid stain is applied over the masking composition. Preferably, the masking composition includes a mixture of water, loess, clay, bicarbonate of soda, and optionally includes sand. The masking composition serves as a mask to prevent the acid stain from staining the portions of the substrate covered by the masking composition, while allowing the acid stain to contact the portions of the substrate not covered by the masking composition. A chemical reaction occurs between the acid stain and the substrate. Any excess material is removed revealing the substrate having characteristics of an antiqued surface, such as a mottled or variegated design. Other systems and methods are also provided.

### TECHNICAL FIELD

The present invention is generally related to a masking systems and, more particularly, is related to a masking composition for imparting an antiquing characteristic to a concrete surface.

BACKGROUND OF THE INVENTION

The use of concrete as a finish surface has grown in popularity over the years. Historically, concrete was used in industrial settings or environments where the concrete was not finished and therefore the natural look and feel of poured concrete was acceptable. Examples of uses of untreated concrete include garage floors, shop floors, outdoor walking surfaces, etc. In those instances, the finished surface typically was gray in color and the surface was not polished.

The use of concrete has grown beyond industrial, exterior, or shop environments. Concrete is now utilized in many ways such as, for example, flooring surfaces, wall surfaces, countertop surfaces, back splashes, table tops, among others. Attempts were made to improve the look and finish of the concrete surface. For example, applying color to the concrete by painting the concrete surface was one method used to vary the look of the finished concrete floor. However, over time, the painted concrete surface would deteriorate, causing the painted floor to chip, crumble, dull and become unseemly and hazardous.

As concrete has become more widely used in residential and commercial settings a more reliable and safe method for finishing the concrete surface is needed. Attempts were made to improve the finished surface. For example, the concrete surface was polished to provide a less dull looking and smoother surface. However, consumers continued to demand colors in the finished concrete surface. One method for adding color to concrete is to add a pigment to the concrete mix. This process provide for a solid color throughout the concrete. This process was utilized during the mixing process. Once the concrete had hardened and was in place, this process could not be utilized.

Another method used to add color to the concrete is by staining the surface of the concrete. Using acid stain causes a chemical reaction with the concrete material. The color change varies greatly based on the amount of calcium hydroxide in the concrete, the density or porosity of the concrete surface, and the moisture content in the concrete. A very porous surface results in a fairly uniform shade having very little variegation.

Craftsmen have tried numerous methods to achieve variation in the color of the concrete surface. For example, craftsman have scattered materials such as confetti, corn flakes, or saw dust on the surface of the concrete. Stain, such as acid stain, was sprayed over the surface having the scattered materials and contacting the surface of the concrete around the material, but not contacting the surface under the materials. A problem with this process was that the materials became saturated with the stain and as they were removed, the surface became smeared. Thus, the desired variegated effect was not achieved. Another problem with this method was that the materials could not be utilized on vertical surfaces. Yet another problem with this method was that smearing occurred during clean up.

Thus, a heretofore-unaddressed need exists for a solution that addresses the aforementioned deficiencies and inadequacies.

### SUMMARY OF THE INVENTION

The preferred embodiments of the present invention provide systems and methods for imparting an antiquing characteristic to a concrete surface.

Briefly described, one preferred embodiment of the system, among others, can be implemented as follows. A system for imparting an antiquing characteristics to a substrate comprising a masking composition that includes a solution that includes 0-80% by weight sand, 0-45% by weight water, 0-31% by weight loess, 0-10% by weight clay, and 0-14% by weight bicarbonate of soda. The substrate has a first layer of acid stain applied thereon. The masking composition is applied over the substrate having the acid stain. A second layer of acid stain is applied over the masking composition. A chemical reaction occurs between the acid stain and the substrate. The masking composition is removed revealing the substrate having characteristics of an antiqued surface, such as a mottled or variegated design.

The preferred embodiment of the present invention can also be viewed as providing methods for imparting antiquing characteristics to a substrate. In this regard, one embodiment of such a method, among others, can be broadly summarized by the following steps: applying an acid stain to the substrate, applying a masking composition onto the substrate, wherein the masking composition includes a solution having 0-80% by weight sand, 0-45% by weight water, 0-31% by weight loess, 0-10% by weight clay and 0-14% by weight bicarbonate of soda. Applying another layer of acid stain over the masking composition. Time is allowed for the acid stain to chemically react with the masking composition and areas of the substrate not covered by the masking composition. Subsequent layers of acid stain and masking composition can be applied. Upon removal of the masking composition and any residual acid stain from the substrate, the substrate is revealed having a mottled or variegated appearance thereon.

The preferred embodiment of the present invention can also be viewed as providing methods for making a solution for imparting antiquing characteristics on a substrate. In this regard, one embodiment of such a method, among others, can be broadly summarized by the following steps: providing an amount of water, loess, clay and bicarbonate of soda in a container, and blending the water, loess, clay and bicarbonate of soda into a coating composition. In another preferred embodiment, the method includes providing sand can be added to the combined mixture.

Other systems, methods, features, and advantages of the present invention will be or become apparent to one with skill in the art upon examination of the following drawings and detailed description. It is intended that all such additional systems, methods, features, and advantages be included within this description, and be within the scope of the present invention.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a top view depicting a preferred embodiment of a substrate having imparted thereon antiquing characteristics according to one aspect of the invention.

FIG. 2 is a side view depicting a preferred embodiment of an illustrative example of a system for implementing antiquing characteristics on a substrate.

FIG. 3 is a flow chart depicting general functionality (or method) of a preferred embodiment for making a masking composition for imparting an antiquing characteristic on a substrate.

FIG. 4 is a flow chart depicting general functionality (or method) of a preferred embodiment for imparting antiquing characteristics on a substrate utilizing a masking composition of FIG. 3.

FIG. 5A is a side view of an illustrative example of a system for implementing a masking composition for imparting antiquing characteristics by first applying a base coat, for example, acid stain on a substrate.

FIG. 5B is a side view of an illustrative example of the system of FIG. 5A for implementing a masking composition for imparting antiquing characteristics by applying a masking composition over the acid stain.

FIG. 5C is a side view of an illustrative example of the system of FIG. 5B for implementing a masking composition for imparting antiquing characteristics by applying a second layer of acid stain on the substrate.

FIG. 6A is a top view depicting an illustrative example of masking a substrate of a system for imparting an antiquing characteristic on a substrate.

FIG. 6B is a top view depicting an illustrative example of a substrate of FIG. 6A having an antiquing characteristic depicted thereon.

### DETAILED DESCRIPTION OF THE PREFERRED EMBODIMENTS

Disclosed herein are systems and methods for imparting an antiquing characteristic to a substrate. To facilitate description of the inventive system, an example systems and methods for imparting an antiquing characteristic to a substrate are discussed with reference to the figures. Although these systems are described in detail, it will be appreciated that these systems are provided for purposes of illustration only and that various modifications are feasible without departing from the inventive concept. For example, while several embodiments are described in connection with these drawings, there is no intent to limit the invention to the embodiment or embodiments disclosed herein. On the contrary, the intent is to cover all alternatives, modifications, and equivalents. Additionally, while the following description and accompanying drawing specifically describe imparting antiquing characteristics to a substrate, it will be clear to one of ordinary skill in the art that the systems and methods presented herein may be extended to other surfaces such as cement, concrete, and vertical surfaces such as a wall, etc. After the example system has been described, an example of the operation of the system will be provided to explain one manner in which the system can be used to provide for the deployment of a process for imparting antiquing characteristics to a substrate.

Referring now in more detail to the drawings, in which like numerals indicate corresponding parts throughout the several views, FIG. I is a top view depicting a preferred embodiment of a substrate 100 having imparted thereon antiquing characteristics 102 in accordance with one aspect of the invention. In an illustrative example, substrate 100 includes, but is not limited to materials such as concrete, cement, ceramic, masonry, and natural stone, among others. The substrate 100 is not limited to horizontal surfaces and also includes vertical services. In a preferred embodiment, substrate 100 comprises a porous surface capable of imbibing a liquid, such as an acid stain. A preferred substrate 100 includes concrete which is particularly subject to staining. Antiquing characteristics 102 include, but are not limited, attaining a decorative appearance on the treated substrate 100 wherein a mottled or variegated design is achieved.

In an example, the substrate 100 includes a layer of stain, preferably concrete acid stain 104. Concrete acid stain 104 is utilized to decorate concrete surfaces by chemically changing the color of concrete. Acid stain 104 is preferably made from a combination of water, acid, for example, hydrochloric or phosphoric, and certain mineral salts. The acid penetrates the concrete surface and carries the salts into a surface of concrete setting up a chemical reaction with the salts and calcium hydroxide in concrete. Varying the salt used results in different colors of the concrete. In one embodiment, a base layer of acid stain 104 is applied over the entire upper surface 106 of the substrate 100. In an alternative embodiment, acid stain 104 is applied only on designated areas of the upper surface 106 of the substrate 100. For example, a portion of the upper surface 106 of the substrate 100 can be masked or covered such that areas underneath the masking do not receive acid stain 104.

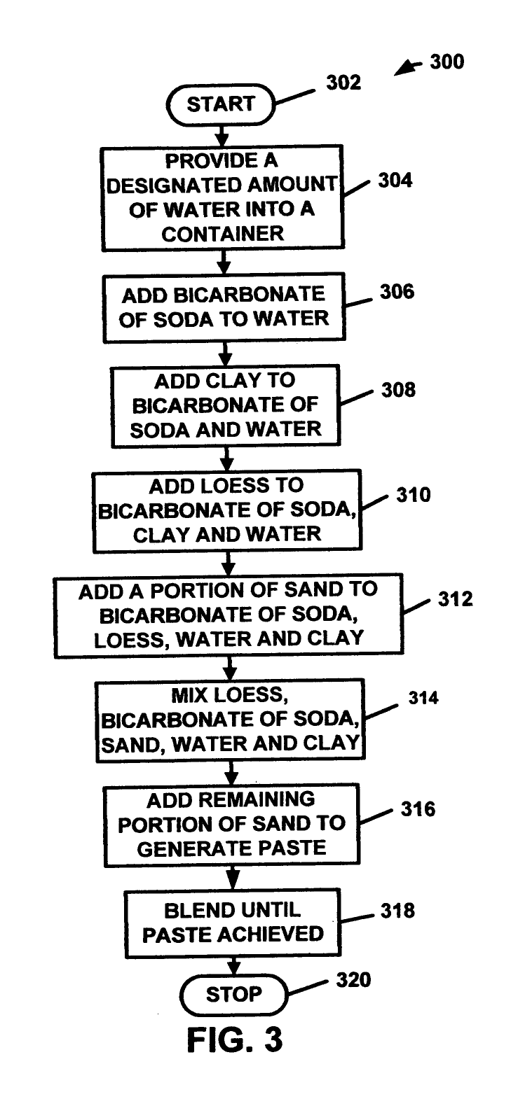

A masking composition (shown in FIG. 2) is applied over the upper surface 106 of the substrate 100. In a preferred embodiment, the masking composition includes a solution that includes water, sand, loess, clay and bicarbonate of soda. The solution is mixed or blended until a paste consistency is achieved. In an alternative embodiment, the solution includes water, loess, clay and bicarbonate of soda. This solution is mixed until a paste consistency is achieved. In this embodiment, sand is not utilized resulting in a thinner paste. In an example, representative materials include Arm and Hammer Baking Soda® for the bicarbonate of soda, loess can be obtained from the soil near Memphis, Tenn., and play sand and clay are available at any home improvement store.

In an embodiment, the paste is made of graded sand up to 80% by weight, water up to 20% by weight, loess up to 10% by weight, clay up to 5% by weight, and bicarbonate of soda up to 8% by weight. The sand adds body to the paste and acts as an aggregate to the matrix of materials. The loess and clay binds the matrix together and provides the stickiness that keeps the paste in place on both horizontal and vertical surfaces, and helps in the absorption of the acid stain. The bicarbonate of soda provides a base or the alkali that neutralizes the acid stain.

In a preferred embodiment, the ratios of these materials can vary by the following percentages by weight:

| | | |
|---|---|---|
| Graded sand medium to fine | 50-80% | by weight |
| Water | 10-20% | by weight |
| Loess | 5-10% | by weight |
| Clay | 2-5% | by weight; and |
| Bicarbonate of soda | 3-8% | by weight. |

In an alternative preferred embodiment, the ratios of these materials can vary by the following percentages by weight:

| | | |
|---|---|---|
| Graded sand medium to fine | 0-70% | by weight |
| Water | 0-13.5% | by weight |
| Loess | 0-9.4% | by weight |
| Clay | 0-10% | by weight; and |
| Bicarbonate of soda | 0-4.1% | by weight. |

In yet another preferred embodiment, the paste is blended without sand using the following percentages by weight:

| | | |
|---|---|---|
| Water | 0-45% | by weight |
| Loess | 0-31% | by weight |
| Clay | 0-10% | by weight; and |
| Bicarbonate of soda | 0-14% | by weight. |

A second layer of acid stain (shown in FIG. 2) is applied over the masking composition. In an embodiment, the masking composition serves as a mask to prevent acid stain applied to the substrate 100 from staining the portions of the substrate 100 covered by the masking composition, while allowing the acid stain 104 to contact the portions of the substrate 100 that are not covered by the masking composition. Time is allowed for the second layer of acid stain 205 to react with the substrate 100 to stain the substrate 100. Preferably, the masking composition absorbs and neutralizes the second layer of acid stain 205 and can be removed such as by scrapping the surface of the substrate 100 without smearing the mottled or variegated appearance 102 (only a few numbered for ease of viewing) of the decorated surface of the substrate 100.

FIG. 2 is a side view 200 depicting a preferred embodiment of an illustrative example of a system for imparting antiquing characteristics on a substrate 100. In a preferred embodiment, the substrate 100 is a concrete surface. In an example, the concrete surface 100 has a first layer of acid stain 104 provided thereon. Acid stain 104 can be applied to the concrete surface 100 by utilizing for example, a pump up garden sprayer. In an embodiment, the color of the acid stain 104 is light, such as, for example light tan. Acid stain 104 is utilized to chemically change the color of the concrete surface 100. Preferably, the acid stain 104 as is known in the art is made from a combination of water, acid, usually hydrochloric or phosphoric, and certain mineral salts. The concrete surface 100 typically includes calcium hydroxide. Acid stain 104 penetrates the concrete surface 100 and carries the salts into the concrete surface 100 causing a chemical reaction with the salts and the calcium hydroxide in the concrete surface 100 resulting in a color change.

A masking composition 204 in accordance with the invention is applying to the concrete surface 100. In a preferred embodiment, the masking composition 204 is applied in a pattern. The masking composition 204 can be applied utilizing for example, a dash brush, a hopper gun, a perforated container such as a salt shaker, or thrown on by hand, among others. Patterns may be selected by the user to accentuate certain portions of the concrete surface 100 by for example providing more or less masking composition 204 or allowing for a random pattern. For example, the masking composition 204 can be applied over the acid stain 104 only, over the concrete surface 100 only or over a combination of the acid stain 104 and concrete surface 100. Preferably the masking composition comprises a paste.

A second layer of acid stain 205 is applied to the concrete surface 100. In an example, the second layer of acid stain 205 is a dark color such as black. The masking composition 204 serves as a mask to prevent the acid stain 205 from staining the portions of the concrete surface 100 covered by the masking composition 204, while allowing the acid stain 205 to contact the portions of the concrete surface 100 not covered by the masking composition.

Time is allowed for the paste 204 to chemically react with the acid stain 205 by absorbing and neutralizing the acid stain 205 where the base coat of acid stain 104 contacts the second layer of acid stain 205 causes a change of appearance in the concrete surface 100 for example, a fading, mottled or variegated appearance. Upon completion of the chemical reaction, excess residual remaining paste 204 and acid stain 104 can be removed without causing the acid stain to smear the decorated concrete surface 100.

In an alternative preferred embodiment of the invention, to achieve a variety of antiquing characteristic on the concrete surface 100, subsequent layers of acid stain 104 of varying colors are applied on top of the paste 204. For each additional layer of acid stain 205, another layer of paste 204 is applied over the acid stain 205.

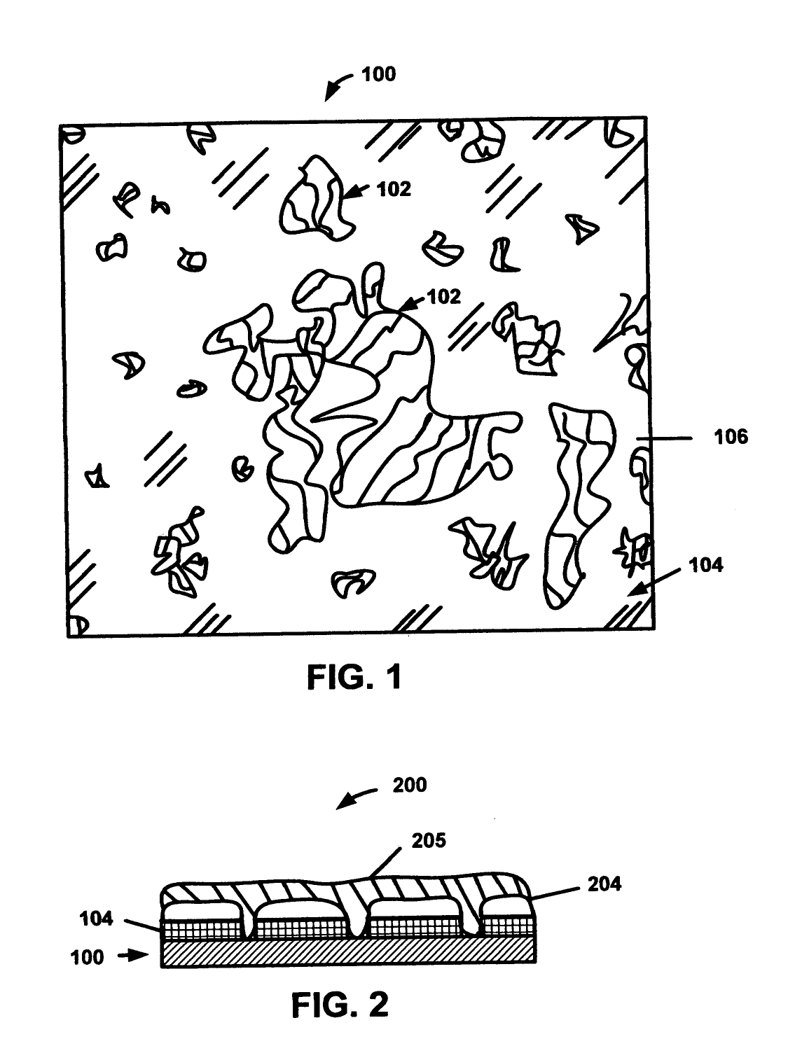

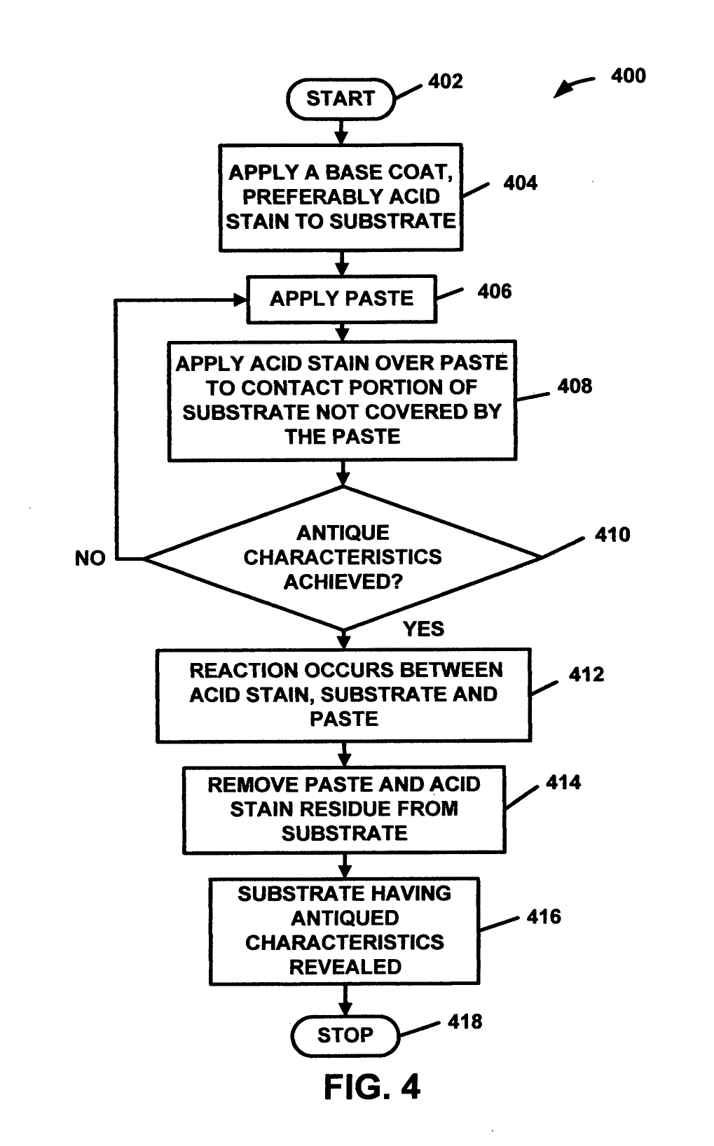

FIG. 3 is a flow chart 300 depicting general functionality of a preferred embodiment for making a masking composition for imparting an antiquing characteristic on a substrate. The process begins at 302. In an embodiment, the amounts utilized to make the masking composition are the amounts described above in the discussion of FIG. 1. At 304, a designated amount of water is provided to a container. At 306, bicarbonate of soda is added to the water provided at 304. At 308, clay is added to the mixture of water and bicarbonate of soda. Loess is added to the mixture of water, clay, and bicarbonate of soda at 310. In an alternative embodiment, sand is not utilized in making the masking composition. If sand is not utilized, the next step of the process is eliminated. At 312, if sand is utilized in the masking composition, a designated portion of sand is added to the mixture of clay, water, loess, and bicarbonate of soda. At 314, the materials are mixed together. The remaining portion of sand is added to the mixture at 316. In an embodiment where sand is not utilized, this step is not performed.

In an embodiment, the materials are mixed until blended into a paste consistency, such as at 318. In a preferred embodiment, the materials are blended until a sticky blended paste is achieved. The materials can be blended manually by hand or utilizing automated mixing methods as are known in the art. The process ends at 320.

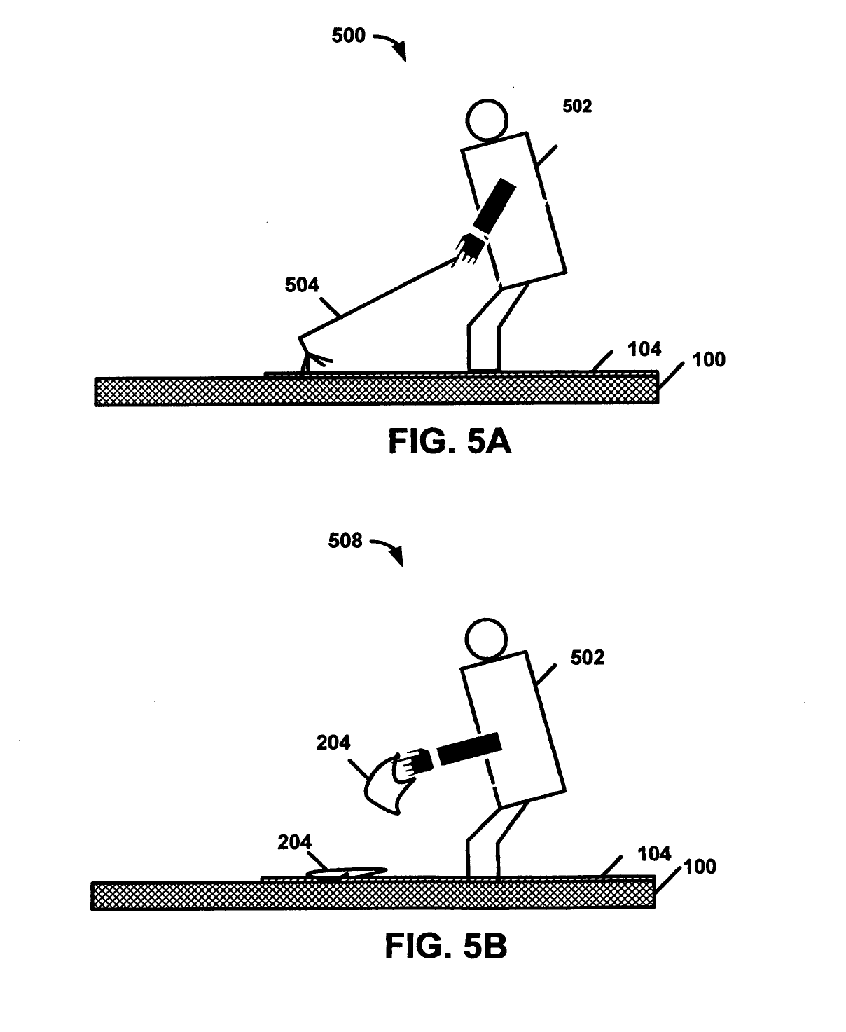

FIG. 4 is a flow chart 400 depicting general functionality of a preferred embodiment for imparting antiquing characteristics on a substrate utilizing a masking composition of FIG. 3. The process begins at 402. In a preferred embodiment, at 404, a base coat of acid stain is applied to the substrate. A base coat can include for example, a tan acid stain. If a base coat is not required step 402 can be skipped and the process continues at 406. At 406, paste is applied to the base coat. Preferably, the paste is applied in a selected pattern. Alternatively, the paste is applied randomly over the base coat or substrate. In still another alternative, the paste is applied in such a manner as to completely cover the base coat or substrate. In yet another alternative, the base coat or substrate has been masked off using paste, for example, so that the acid stain is not applied to areas protected by the masking.

At 408, acid stain is applied over the paste in such as manner as to contact a portion of the substrate not covered by paste. Preferably, the acid stain does not contact the substrate surface under the paste. At 410, a determination is made as to whether the desired combination of the paste and acid stain has been achieved. If no, the process continues at 406. If yes, at 412, no additional layers of acid stain and paste are provided and a reaction occurs between the acid stain, paste and concrete surface. Time is allowed for the acid stain to chemically react with the substrate, i.e., the concrete surface imparting a color change to the concrete surface. The paste has absorbed and neutralized the acid stain.

At 414, the paste and any acid stain residue are removed from the substrate. Because the paste has absorbed and neutralized the acid stain, the paste and acid stain residue can be scrapped up from the substrate without smearing the decorated substrate. At 461, the substrate is revealed having antiqued characteristics imparted thereon. Preferably the decorated substrate is washed, dried and sealed, using well known sealing techniques. The process ends at 418.

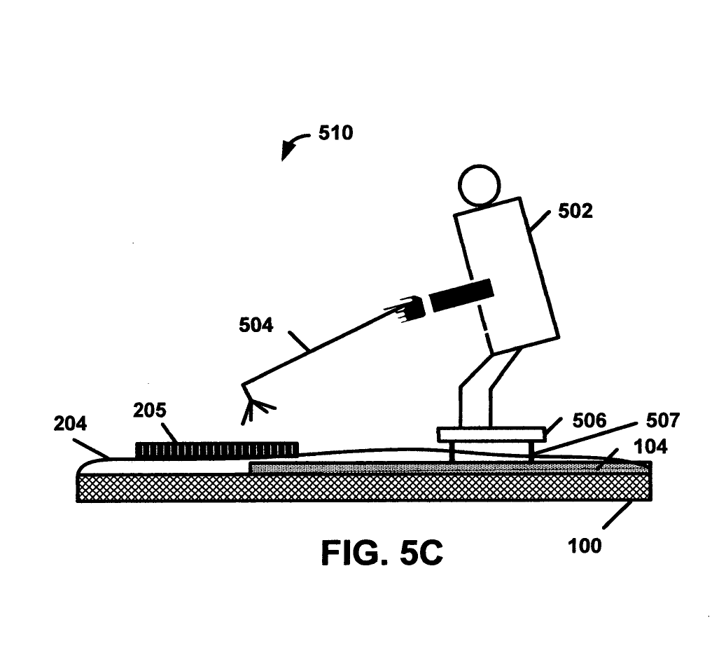

FIGS. 5A, 5B, and 5C are side views of preferred embodiments of an illustrative example of a system for implementing a masking composition for imparting antiquing characteristics on a substrate. Referring to FIG. 5A, a side view of an illustrative example of a system 500 for implementing a masking composition for imparting antiquing characteristics by first applying a base coat such as an acid stain on a substrate is shown. An installer 502 is positioned on the substrate 100 to apply a base coat or a layer of acid stain 104. In an embodiment, the substrate 100 is stained by spraying the acid stain 104 onto the substrate 100 using a pump up garden sprayer 504. It is to be understood that while one layer of acid stain 104 is shown being applied to the substrate, multiple layers of acid stain 104 that include varying colors can be applied to the substrate 100 to achieve a desired color or combination of colors.

Referring to FIG. 5B, a side view of an illustrative example of the system of FIG. 5A for implementing a masking composition for imparting antiquing characteristics by applying a masking composition over the acid stain is shown. The installer 502 has completed applying acid stain 104 as described in FIG. 5A, and is ready to apply the masking composition 204. The masking composition 204 can be applied utilizing for example, a dash brush, a hopper gun, a perforated container such as a salt shaker or thrown on by hand as shown in FIG. 5B. In an alternative preferred embodiment when sand is not used, the masking composition 204 is a thinner consistency. In this embodiment, the masking composition 204 can be applied using for example, a garden hose and a sprayer unit available at a home improvement store.

Referring to FIG. 5C, is a side view 510 of an illustrative example of the system of FIG. 5B for implementing a masking composition for imparting antiquing characteristics by applying a second layer of acid stain on the substrate. After the processes of FIG. 5B have been completed, the substrate 100 has thereon at least one layer of acid stain 104 and a layer of masking composition 204. A second layer of acid stain 205 is applied using for example the sprayer 504. In an embodiment, the installer 504 wears spiked shoes (not shown) to avoid negatively impacting the masking composition 204 by for example, smearing the masking composition 204. In a preferred embodiment, the installer 502 stands on a knee board 506 having spikes 507 affixed thereto. As the installer 502 moves about the substrate 100, the installer 502 places the knee board 506 in front of him and steps on it. The installer 502 then removes the knee board 506 positioned behind him and places the knee board 506 where he plans to step next. The installer 502 repeats this process until all of the selected areas to receive acid stain 205 have been stained.

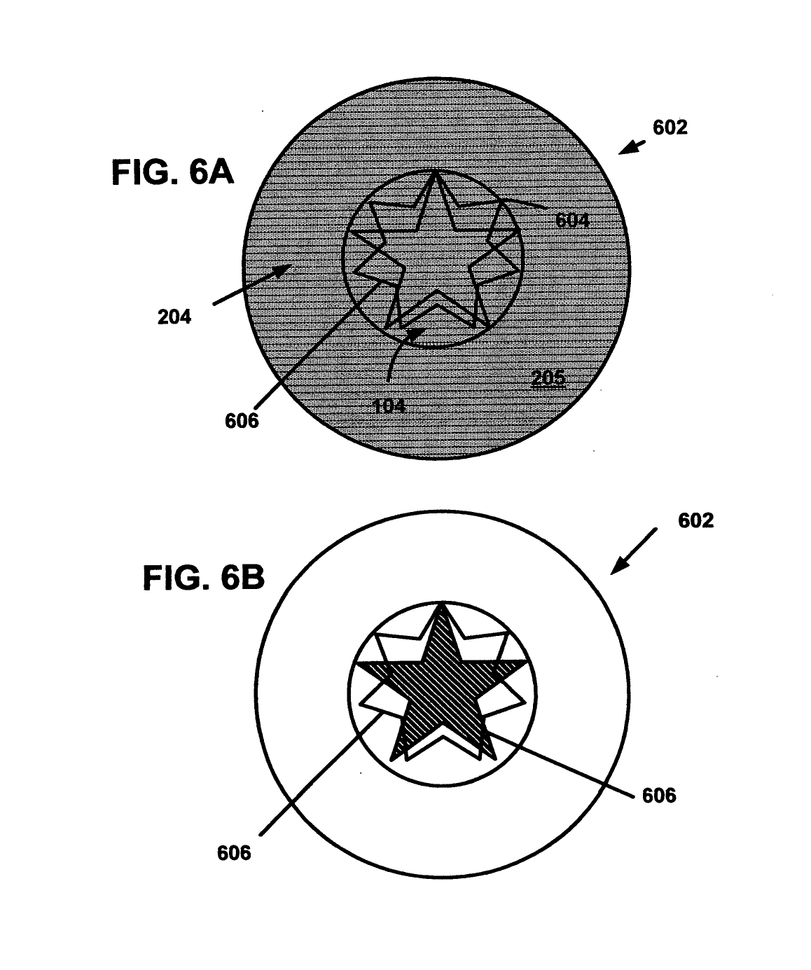

FIG. 6A is a top view depicting an illustrative example of masking a substrate of a system for imparting an antiquing characteristic on a substrate. Masking can be achieved utilizing the masking composition 204. In the illustrative example of FIG. 6A, a substrate 602 has been scored 604 to separate the area to achieve a distinctive appearance. Scoring can be achieved utilizing for example, a saw having a diamond blade. Scoring is also achieved without the use of a saw by using the masking composition 204 to mask areas in which a distinctive appearance is desired. Scoring can be used to achieve a variety of decorative appearances of the scored substrate 602, for example, the appearance of tile floors, distinctive backsplashes, and distinctive shapes, among others. As shown in illustrative example of FIG. 6A, the star shapes 606 are achieved by scoring. A base coat of acid stain 104 is applied to the scored substrate 602. Alternatively, acid stain 104 is applied only to scored areas to achieve a difference affect.

Masking composition 204 is applied to the entire scored substrate 602. The masking composition 204 serves to mask the scored areas such that the next layer of acid stain does not penetrate into the masked areas. A second layer of acid stain 205 is applied over the masking composition 204.

FIG. 6B is a top view depicting an illustrative example of the substrate of FIG. 6A having an antiquing characteristic depicted thereon. Time is allowed for acid stain 205 to chemically react with the scored substrate 602. Once the masking composition 204 and residual acid stain 104 is removed from the scored substrate 602, the decorative star shapes 606 are revealed. In an embodiment, each of the star shapes 606 have different shading due to varying colors of acid stain 104 being utilized. In an alternative embodiment, other shapes are revealed due to a different shape being scored or masked by the masking composition 204 on the scored substrate 602.

In one aspect of the invention, the inventive masking composition is utilized with a horizontal surface. In another aspect of the invention, the inventive masking composition is utilized with a vertical surface. In still another aspect of the invention, the inventive masking composition provides for easy removal of residual materials from the decorated surface. In yet another aspect of the invention, the inventive masking composition prevents smearing of the acid stain on a decorated surface during clean up. Further, tools and containers used to make and use the inventive masking composition can be easily cleaned with water.

Any process descriptions or blocks in flow charts should be understood as representing modules, segments, or steps for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The preferred embodiment of the present invention provides systems and methods for imparting antiquing characteristics to a substrate. In an illustrative example, a masking composition such as a paste is blended with 70% medium graded sand, 13.5% water, 9.4% loess, 3.0% clay, and 4.1% bicarbonate of soda, with ratios by weight. A twelve inch by twelve inch square of concrete is acid stained with 2 coats of light tan stain. The paste is applied with a dash brush in a pattern that covers most of the concrete surface but randomly, areas are left uncovered. A black stain is applied with a pump up garden sprayer. The stain contacts the portions of the concrete surface not covered by the paste but does not cover the paste covered portions of the concrete surface. Time is allowed for a chemical reaction to occur. The acid stain atop the thickest parts of the paste are completely absorbed and do not contact the surface of the concrete surface. The adjacent areas of the concrete surface not covered by the paste are fully contacted by the acid stain and fully stained by the black acid stain. The margins where the paste is thinner are partially stained by the black acid stain giving a fading edge to the back areas and resembling the look of marble or stone.

In another illustrative example of imparting an antiquing characteristic to a concrete surface, the paste is blended without sand. In an example, the paste comprises 45% water, 14% bicarbonate of soda, 10% clay, and 31% loess, by weight. This combination results in a thinner paste than the above example. Circles are scored in the concrete surface. The entire concrete surface is stained with two coats of light tan acid stain. The paste is dashed on the scored circles with dash brushes leaving parts of the circle covered and the remaining parts exposed. A solid coat of the paste is applied around the circle to mask off the surrounding concrete surface with a paint brush. A coat of reddish brown acid stain is sprayed with a pump up garden sprayer on the circle contacting the concrete surface where the paste did not cover the concrete surface, but not contacting the concrete surface underneath the paste, and not contacting the concrete surface surrounding the circle due to the mask of paste. A second coat of paste is dashed over the first coat of paste covering and protecting a portion of the reddish brown acid stain but in such a pattern that a small portion of the concrete surface is still exposed. A coat of black acid stain is sprayed over the circle contacting only the exposed concrete surface where there was no paste. Time is allowed for the chemical reaction of the acid stain and the concrete surface. The entire concrete surface is cleaned by washing up the paste and the acid stain residue. After the concrete surface dries, a coat of concrete sealer is applied. The effect is a variegated pattern that has separated colors but faded edges such as seen in marble or stone.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A masking composition, comprising:
a solution of water; and
an effective amount of materials further comprising loess, clay, and bicarbonate of soda added to the solution to form a paste.

2. The masking composition of claim 1, wherein the materials further comprises 0-45% by weight water, 0-31% by weight loess, 0-10% by weight clay, and 0-14% by weight bicarbonate of soda.

3. The masking composition of claim 1, further comprises sand added to the solution.

4. The masking composition of claim 3, wherein the materials further comprises 0-80% by weight sand, 0-45% by weight water, 0-31% by weight loess, 0-10% by weight clay, and 0-14% by weight bicarbonate of soda.

5. The masking composition of claim 3, wherein the materials further comprises 0-70% by weight sand, 0-13.5% by weight water, 0-9.4% by weight loess, 0-3% by weight clay, and 0-4.1% by weight bicarbonate of soda.

6. The masking composition of claim 3, wherein the materials further comprises 0-80% by weight sand, 0-20% by weight water, 0-10% by weight loess, 0-5% by weight clay, and 0-8% by weight bicarbonate of soda.

7. A method for imparting antiquing characteristics to a substrate, comprising the steps of:
applying a first layer of acid stain to the substrate;
applying a masking composition onto the substrate, wherein the masking composition comprises a solution comprising 0-80% by weight sand, 0-45% by weight water, 0-31% by weight loess, 0-10% by weight clay, and 0-14% by weight bicarbonate of soda;
applying a second layer of acid stain to the substrate; and
allowing the second layer of acid stain to chemically react with the masking composition and areas of the substrate not covered by the masking composition.

8. The method of claim 7, further comprising continuing to apply layers of acid stain and masking composition to achieve desired mottled or variegated characteristics.

9. The method of claim 7, further comprising masking areas of the substrate such that the masked areas of the substrate do not receive the acid stain.

10. The method of claim 7, wherein the applying a masking composition onto the substrate is performed by applying the masking composition in a pattern.

11. The method of claim 7, further comprising removing the masking composition and residual second layer of acid stain from the substrate and revealing the substrate having mottled or variegated appearance thereon.

12. The method of claim 7, further comprising standing on a knee board placed on the substrate, the level having protruding spikes on a exterior surface such as to avoid smearing the masking composition during application of the second layer of acid stain.

13. The method of claim 7, wherein the applying a masking composition onto the substrate is performed manually by hand, utilizing a dash brush, utilizing a garden hose sprayer, utilizing a hopper gun or utilizing a perforated container.

14. The method of claim 7, wherein the applying a first layer of acid stain to the substrate and applying a masking composition onto the substrate is performed on a substrate comprising a concrete surface.

15. A method for making a solution for imparting antiquing characteristics, comprising the steps of:
providing water, loess, clay and bicarbonate of soda in a container; and
blending the water, loess, clay and bicarbonate of soda into a combined mixture.

16. The method of claim 15, further comprising adding sand to the combined mixture until achieving a paste consistency.

17. The method of claim 16, wherein the combined mixture further comprises sand of medium or fine grade up to 80% by weight, water up to 20% by weight, loess up to 10% by weight, clay up to 5% by weight and bicarbonate of soda up to 8% by weight.

18. The method of claim 16, wherein the mixture further comprises medium graded sand up to 70% by weight, water up to 13.5% by weight; loess up to 9.4% by weight, clay up to 3% by weight, and bicarbonate of soda up to 4.1% by weight.

19. The method of claim 15, wherein the mixture further comprises water up to 45% by weight; loess up to 31% by weight, clay up to 10% by weight, and bicarbonate of soda up to 14% by weight.

20. The method of claim 15, wherein the blending the water, loess, clay and bicarbonate of soda into a combined mixture is performed until the combined mixture achieves a paste consistency.
